(19) United States
(12) Patent Application Publication
(10) Pub. No.: US 2016/0292453 A1
(43) Pub. Date: Oct. 6, 2016

(54) HEALTH CARE INFORMATION SYSTEM AND METHOD FOR SECURELY STORING AND CONTROLLING ACCESS TO HEALTH CARE DATA

(71) Applicant: McKesson Corporation, San Francisco, CA (US)

(72) Inventors: Chris Patterson, Oakland, CA (US); Arien Malec, Oakland, CA (US)

(21) Appl. No.: 14/673,949

(22) Filed: Mar. 31, 2015

(51) Int. Cl. G06F 21/62; H04L 9/08; G06F 21/78

(52) U.S. Cl. CPC G06F 21/6245; G06F 21/78; H04L 9/0825

(57) ABSTRACT

A health care information system and method are provided to securely store and control access to health care data. A key management and decryption system includes processing circuitry configured to receive encrypted health care data, representations of a health care context and a time value associated with the health care data, and authorization information associated with a requestor that has requested access to the health care data. The processing circuitry is also configured to determine whether the requestor is authorized to access the health care data based upon an analysis of the authorization information relative to the health care context and the time value associated with the health care data. In an instance in which the requestor is authorized to access the health care data, the processing circuitry is configured to decrypt the health care data and to provide the decrypted version of the health care data.

### TECHNOLOGICAL FIELD

An example embodiment of the present invention relates generally to a health care information system and method and, more particularly, to a health care information system and method for securely storing and controllably providing access to health care data.

### BACKGROUND

Health care information systems receive, process and output of wide variety of health care data. For example, health care information systems may work with different types of health care data including data relating to the medical history of a patient, clinical data, patient data defining the birth date, address and other personal information, data relating to the result of various tests or procedures or the like. The health care data may be received by health care information systems from a wide variety of sources and the health care information systems may, in turn, provide output to a wide variety of recipients. For example, health care information systems may receive and/or provide data to various health care providers, patients, laboratories, pharmaceutical companies or the like.

At least a portion of the health care data is sensitive or otherwise confidential and, as such, should be protected by the health care information system such that access to the health care data is controlled or otherwise limited. For example, a significant portion of the health care data has a privacy level that is governed by the Health Insurance Portability and Accountability Act (HIPAA) or other regulatory framework and that dictates the manner in which the health care data is to be securely stored and access is to be controlled. Additionally, some health care data is subjected to different levels of privacy and, in some instances, greater levels of privacy based upon, for example, the data type, the data source or the recipient. For example, health care data related to mental health and/or substance abuse may be subjected to heightened levels of privacy. Further, health care data provided by certain data sources may be required to be segregated and to have access differently controlled. In this regard, health care data provided by organizations, such as military organizations, that have more restricted confidentiality requirements may also be subject to heightened levels of privacy.

In addition to taking measures to protect the health care data from unintended access in the manner defined by the privacy level associated with the health care data, the extent to which the protected health care data would be accessible in the event of a breach of the data security is also of import with such unauthorized access preferably being limited as much as possible feasible. In this regard, the limitations on the extent of any such data breach is of particular concern in instances in which the health care data has been stored in the cloud or other multi-tenant architecture as a result of the number of potential individuals who may access the health care data and the impact of a breach across multiple covered entities. Common security measures include data and physical security as well as disk or database level encryption. By utilizing such security measures, access to the health care data is limited to only authorized users. However, the authorized users generally have access to all health care data. Thus, unauthorized access or unauthorized use by authorized users potentially exposes all health care data, thereby creating the possibility of a more sizeable data breach than may be first imagined.

### BRIEF SUMMARY

A health care information system and method are provided in accordance with an example embodiment in order to securely store and control access to health care data. In an example embodiment, the health care information system and method securely stores and controls access to the health care data in such a manner that not only is access to the health care data generally limited, but the data to which an unauthorized user could gain access is appreciably limited. As such, the extent of any data breach may be correspondingly limited, such as both in regards to the time interval associated with the data and the context of the data that could be accessed in the event of a data breach.

In an example embodiment, a key management and decryption system is provided that is configured to secure health care data. The key management and decryption system includes processing circuitry configured to receive encrypted health care data, representations of a health care context and a time value associated with the health care data and authorization information associated with a requestor that has requested access to the health care data. The health care context of an example embodiment includes one or more of a health care organization, a patient, a level of sensitivity associated with the health care data, a health care practice that provided the health care data or a health care system that received the health care data. The processing circuitry is also configured to determine whether the requestor is authorized to access the health care data based upon an analysis of the authorization information relative to the health care context and the time value associated with the health care data. In an instance in which the requestor is authorized to access the health care data, the processing circuitry is configured to decrypt the health care data and to provide the decrypted version of the health care data.

The processing circuitry of an example embodiment is further configured to access an asymmetric encryption key pair including a first asymmetric encryption key that is associated with a second asymmetric encryption key with which the health care data is encrypted. The processing circuitry of this example embodiment is configured to decrypt the health care data by decrypting the health care data with the first asymmetric encryption key. The processing circuitry of an example embodiment is further configured to receive a request for an asymmetric encryption key. The request for the asymmetric encryption key includes the health care context and the time value associated with the health care data to be encrypted. The processing circuitry of this example embodiment is further configured to determine the second asymmetric encryption key that is at least partially based on the health care context and the time value. The processing circuitry of this example embodiment is further configured to provide the second asymmetric encryption key in response to the request. The processing circuitry of an example embodiment is further configured to associate different asymmetric encryption key pairs with health care data associated with different health care context and different time values. The processing circuitry of this example embodiment is configured to associate different asymmetric encryption key pairs by generating asymmetric encryption key pairs based on the health care context at a time interval.

In another example embodiment, a method of a key management and decryption system for securing health care data is provided that includes receiving encrypted health care data, representations of a health care context and a time value associated with the health care data as well as authorization information associated with a requestor that has requested access to the health care data. The health care context of an example embodiment includes one or more of a health care organization, a patient, a level of sensitivity associated with the health care data, a health care practice that provided the health care data or a health care system that received the health care data. The method also includes determining whether the requestor is authorized to access the health care data based upon an analysis of the authorization information relative to the health care context and the time value associated with the health care data. In an instance in which the requestor is authorized access to health care data, the method further includes decrypting the health care data and providing a decrypted version of the health care data.

The method of an example embodiment also includes accessing an asymmetric encryption key pair including a first asymmetric encryption key that is associated with a second asymmetric encryption key with which the health care data is encrypted. The method of this example embodiment decrypts the health care data by decrypting the health care data with the first asymmetric encryption key. The method of this example embodiment also includes receiving a request for an asymmetric encryption key. The request for the asymmetric encryption key includes the health care context and the time value associated with the health care data to be encrypted. The method further includes determining the second asymmetric encryption key that is at least partially based upon the health care context and the time value. The method further includes providing the second asymmetric encryption key in response to the request. The method of an example embodiment also includes associating different asymmetric encryption key pairs with health care data associated with different health care context and different time values. In this regard, the method of an example embodiment associates different asymmetric encryption key pairs by generating asymmetric encryption key pairs based on the health care context at a time interval.

In a further example embodiment, a data storage system is provided that is configured to securely store health care data. The data storage system includes processing circuitry configured to receive health care data having an associated health care context. For example, the health care context may include one or more of a health care organization, a patient, a level of sensitivity associated with the health care data, a health care practice that provided the health care data or a health care system that received the health care data. The processing circuitry of this example embodiment is also configured to request an asymmetric encryption key. The request for the asymmetric encryption key includes the health care context and a time value associated with the health care data. The processing circuitry is further configured to receive the asymmetric encryption key that is at least partially based upon the health care context and a time value and to encrypt the health care data utilizing the asymmetric encryption key. The processing circuitry is further configured to store the health care data as encrypted, along with representations of the health care context and a time value.

The processing circuitry of an example embodiment is configured to receive the asymmetric encryption key by receiving a different asymmetric encryption key for health care data having a different health care context or a different time value. The processing circuitry of an example embodiment is further configured to receive a request for access to the health care data by a requestor. The processing circuitry of this example embodiment is further configured to provide the health care data as encrypted, representations of the health care context and the time value associated with the health care data and authorization information associated with the requestor. In an instance in which the requestor is determined to be authorized to access to health care data, the processing circuitry is further configured to receive a decrypted version of the health care data.

In yet another example embodiment, a method is provided for securely storing health care data with the method including receiving health care data having an associated health care context. The health care context of an example embodiment includes one or more of a health care organization, a patient, a level of sensitivity associated with the health care data, a health care practice that provided the health care data or a health care system that received the health care data. The method of this example embodiment also includes requesting an asymmetric encryption key. The request for the asymmetric encryption key includes the health care context and a time value associated with the health care data. The method of this example embodiment also includes receiving the asymmetric encryption key that is at least partially based upon the health care context and the time value and encrypting the health care data utilizing the asymmetric encryption key. The method of this example embodiment further includes storing the health care data as encrypted, along with representations of the health care context and the time value,

The method of an example embodiment receives the asymmetric encryption key by receiving a different asymmetric encryption key for health care data having a different health care context or a different time value. The method of an example embodiment also includes receiving a request for access to the health care data by a requestor. The method of this example embodiment also includes providing the health care data as encrypted, representations of the health care context and the time value associated with the health care data and authorization information associated with the requestor. In an instance in which the requestor is determined to be authorized to access the health care data, the method further includes receiving a decrypted version of the health care data.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a key management and decryption system or a data storage system that may be specifically configured in accordance with an example embodiment of the present invention;

FIG. 2 is a block diagram of a health care information system that may be specifically configured in accordance with an example embodiment of the present invention;

FIG. 3 is a flowchart of the operations performed, such as by the data storage system of FIG. 1, for encrypting health care data in accordance with an example embodiment of the present invention;

FIG. 4 is a block diagram of the operations performed, such as by the key management and decryption system of FIG. 1, for providing the asymmetric encryption key utilized to encrypt health care data in accordance with an example embodiment of the present invention;

FIG. 5 is a block diagram of the operations performed, such as by the data storage system of FIG. 1, in order to decrypt the health care data in accordance with an example embodiment of the present invention; and

FIG. 6 is a block diagram of the operations performed, such as by the key management and decryption system in order to decrypt health care data in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

A health care information system, method and computer program product are provided in accordance with an example embodiment in order to securely store and controllably provide access to health care data. In this regard, a data storage system, method and computer program product are provided in order to store the health care data in an encrypted form and to cooperate with a key management and decryption system in order to decrypt the health care data so as to provide controlled access to authorized requesters. In addition, a key management and decryption system is provided in order to generate asymmetric encryption key pairs with which the health care data is encrypted by the data storage system. Further, the key management and decryption system of an example embodiment cooperates with the data storage system in order to decrypt the health care data in an instance in which access is requested by an authorized requestor.

In addition to controlling access to the stored data, the health care information system in general and the key management and decryption system and the data storage system in particular are configured to limit the extent to which a data breach would permit an unauthorized user to access the health care data. In this regard, the key management and decryption system of an example embodiment generates the asymmetric encryption key pairs in such a manner that the asymmetric encryption keys are at least partially based upon the health care context and a time value associated with the health care data such that the encryption keys are only appropriate for a subset of the health care data. As such, the health care data that could be accessed in an unauthorized manner, for example as a result of a data breach, is limited both in terms of the health care context of the data that may be accessed and the time values associated with the health care data that may be accessed. Thus, the health care information system, method and computer program product of this example embodiment provide for storage of health care data in a secure manner, controlled access to the health care data by only those requesters having authorization and limitations upon the extent of a data breach based upon the manner in which the health care data is encrypted and stored.

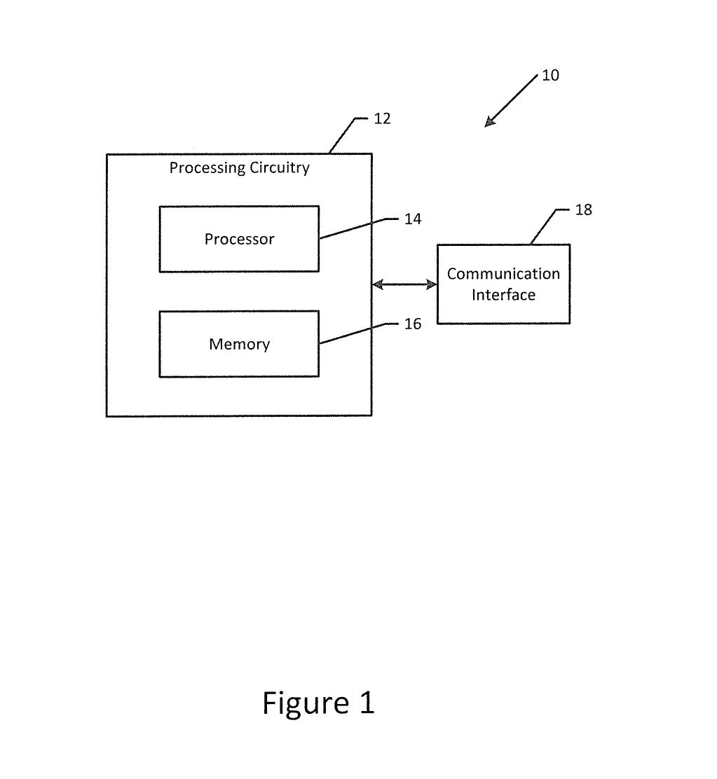

The health care information system may be configured in various manners. The health care information system may be embodied by a variety of different computer systems that are configured to receive, process and output health care information. As shown in FIG. 1 and regardless of the type of computer system that embodies the health care information system, the health care information system or components of the health care information system include or are associated and in communication with processing circuitry 12 that is configurable to perform functions in accordance with one or more example embodiments disclosed herein. In this regard, the processing circuitry may be configured to perform and/or control performance of one or more functionalities of the health care information system or components thereof in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 12 includes a processor 14 and, in some embodiments, such as that illustrated in FIG. 1, further includes memory 16. The processing circuitry may also be in communication with or otherwise control a communication interface 18 for communicating with other computing systems. As such, the processing circuitry may be embodied as a circuit chip (e.g., an integrated circuit chip) configured (e.g., with hardware, software or a combination of hardware and software) to perform operations described herein.

The processor 14 may be embodied in a number of different ways. For example, the processor may be embodied as various processing means such as one or more of a central processing unit, a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities of the computing device as described herein. The plurality of processors may be embodied on a single computing device or distributed across a plurality of computing devices collectively configured to function as the computing device. In some example embodiments, the processor may be configured to execute instructions stored in the memory 16 or otherwise accessible to the processor. As such, whether configured by hardware or by a combination of hardware and software, the processor may represent an entity (e.g., physically embodied in circuitry—in the form of processing circuitry 12) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

The processing circuitry 12 may also include memory 16 as shown in FIG. 1. In some example embodiments, the memory may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The memory may be configured to store information, data, applications, instructions and/or the like for enabling the computing device to carry out various functions in accordance with one or more example embodiments. For example, the memory may be configured to buffer input data for processing by the processor 14. Additionally or alternatively, the memory may be configured to store instructions for execution by the processor. Among the contents of the memory, applications may be stored for execution by the processor in order to carry out the functionality associated with each respective application. In some cases, the memory may be in communication with the processor via a bus or buses for passing information among components of the health care information system 10.

As noted above, the health care information system 10 of the embodiment of FIG. 1, or components of the health care information system also include a communication interface 18. The communication interface is configured to communicate with one or more subscribers in order to affect the delivery of messages thereto. Additionally, the communication interface of an example embodiment may be in communication with one or more sources of messages so as to receive the messages therefrom, which are then to be delivered to the respective subscribers. The communication interface may be any means such as a device or circuitry embodied in either hardware or a combination of hardware and software that is configured to receive and/or transmit messages from sources to subscribers. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication.

The communication interface 18 may be configured to directly and/or indirectly communicate with the sources of messages and/or the subscribers in any of a number of different manners including, for example, any of a number of wireline or wireless communication or networking techniques. Examples of such techniques include, without limitation, Universal Serial Bus (USB), radio frequency (RF), Bluetooth (BT), infrared (IrDA), any of a number of different cellular (wireless) communication techniques such as any of a number of 2G, 2.5G, 3G, 4G or Long Term Evolution (LTE) communication techniques, local area network (LAN), wireless LAN (WLAN) techniques or the like. In accordance with various ones of these techniques, the communication interface can be coupled to and configured to communicate across one or more networks. The network(s) can comprise any of a number of different combinations of one or more different types of networks, including data and/or voice networks. For example, the network(s) can include one or more data networks, such as a LAN, a metropolitan area network (MAN), and/or a wide area network (WAN) (e.g., Internet), and include one or more voice networks, such as a public-switched telephone network (PSTN).

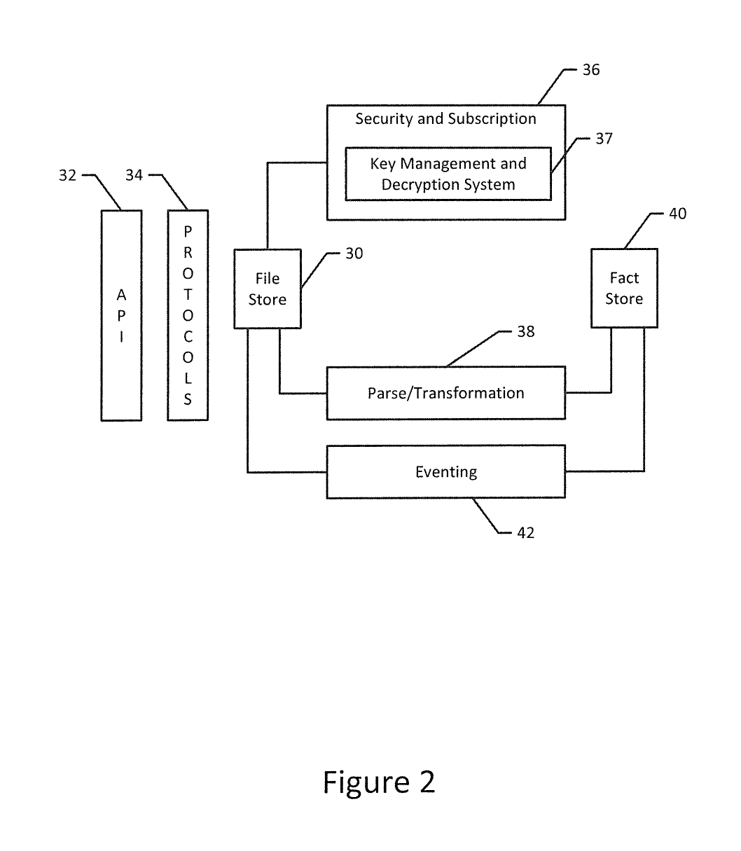

Although not shown in FIG. 1, the health care information system 10 may also include a plurality of additional memory devices in communication with the processing circuitry 12. For example, the health care information system may include first and second memory devices, although the health care information system may include additional memory devices in other example embodiments. The plurality of memory devices, such as the first and second memory devices, may include different types of memory devices depending upon the type of information to be stored by the memory device and the access requirements for the type of information. As described below in conjunction with the embodiment of FIG. 2, for example, the first memory device may serve as a file store and, as such, may be embodied by a type of memory configured to store large amounts of information in an efficient manner, such as a binary large object (BLOB) storage, and the second memory device may be embodied by a key value store or other type of storage configured to efficiently store and access tabular information.

Referring now to FIG. 2, the health care information system 10 in accordance with an example embodiment is depicted. The health care information system of the embodiment of FIG. 2 receives data via an application programming interface (API) 32 that may be embodied, for example, by the communication interface 18, the processing circuitry 12, such as the processor 14, or the like. Prior to storing the data elements that are received via the API within the file store 30, the health care information system may subject the data to one or more protocols 34 in order to obtain a normalized set of facts. The protocols may also be defined and/or implemented by the communication interface, the processing circuitry, such as the processor, or the like. In this regard, the protocols may identify the parse and/or transformation logic to be applied to the data in order to obtain a normalized set of facts. The protocols may be based upon the type of data, the data source and/or the eventual recipient of the data. In this regard, some protocols may apply to all data types. For example, the same protocol may apply to the definition of a person, the definition of an address, etc. regardless of the type of data within which the person or address is defined. In contrast, other protocols are specific to a particular data type or a particular source or intended recipient of the data.

The health care information system 10 of this example embodiment also includes a file store 30 for storing the data received via the API 32 once the corresponding protocols 34 have identified the parse and transformation logic to be associated with the data element. The file store may be embodied by the first memory device and, in one embodiment, is embodied by a type of memory device that efficiently stores large amounts of information, such as BLOB storage. In an example embodiment, the data is hashed, such as by the processing circuitry 12, e.g., the processor 14, prior to storage by the file store.

The data received by the health care information system 10 may be encrypted or otherwise secured, such as with an asymmetric encryption technique utilizing public and private keys. In order to enhance the security associated with the data, the keys may be rotated over the course of time. As such, the health care information system may include security and subscription logic 36, such as may be embodied by the processing circuitry 12, such as the processor 14. The security and subscription logic may, in turn, include a key management and decryption system 37 for securing the health care data. The key management and decryption system may be embodied by a computer system as shown in FIG. 1 and, as described below, may provide asymmetric encryption keys for facilitating the secure storage and controlled access to the health care data.

As described above, the health care information system 10 also includes parse and transformation logic 38, such as may also be embodied by the processing circuitry 12, such as the processor 14. The manner in which a data element is to be processed by the parse and transformation logic is defined by a protocol based upon the data type and/or the data source and intended recipient. The parse and transformation logic is configured to normalize the data element so as to produce a normalized set of facts. The normalized set of facts may be stored, for example, by the fact store 40. In this regard, the fact store may be embodied by a different memory device than the memory device that embodies the file store 30. In this regard, the fact store may be embodied by the second memory device which may be embodied by a type of memory device that efficiently creates and accesses tables, such as a key value store. In addition to the set of normalized facts generated by the parse and transformation logic, the fact store may store a pointer to the location within the file store at which the underlying data elements are stored. Although depicted in FIG. 2 as memory devices, the file store and/or the fact store may be embodied by a data storage system which, in turn, may be embodied by a computer system as shown in FIG. 1 for securely storing the health care data.

As described below, the health care information system 10 of an example embodiment is also configured to create and publish events based upon one or a combination of the data elements. As such, the health care information system of this example embodiment includes eventing logic 42, such as may be embodied by the processing circuitry 12, such as the processor 14.

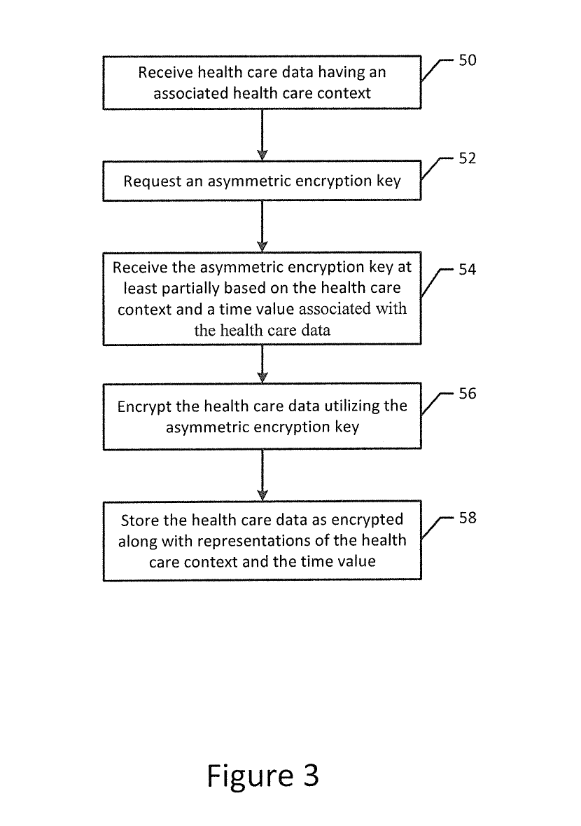

Referring now to FIG. 3, the operations performed, such as by a data storage system, in order to securely store health care data are depicted. As shown in block 50 of FIG. 3, the data storage system includes means, such as the processing circuitry 12, the processor 14, the communication interface 18 or the like, for receiving health care data having an associated health care context. The health care data can be received from any of a variety of sources of health care data including health care organizations, governmental agencies, branches of the military, patients, etc. The health care context may include any of a variety of information associated with the health care data that defines some aspect of the health care data, such as some aspect relating to the health care data itself, the source or recipient of the health care data, the patient, etc. For example, the health care context may include one or more of the health care organization associated with the health care data, such as the health care organization that performed a medical procedure, a test or other function associated with patient care. The health care context may additionally or alternatively include the identification of a patient and/or the level of sensitivity associated with the health care data. For example, the level of sensitivity may identify if the health care data is to be secured in a manner compliant with HIPPA or other regulatory frameworks, or if the health care data is to be secured in accordance with a heightened level of security as required by certain organizations, such as health care data associated with military members. The health care context may also identify the health care practice that provided the health care data, that is, the source of the health care data, or the health care system that received the health care data.

As shown in block 52 in FIG. 3, the data storage system may also include means, such as the processing circuitry 12, the processor 14, the communication interface 18 or the like, for requesting an asymmetric encryption key. In this regard, the data storage system may request the asymmetric encryption key from the key management and decryption system 37 of the health care information system. The request for the asymmetric encryption key also includes the health care context and a time value associated with the health care data to be encrypted with the asymmetric encryption key. The time value may be associated with the health care data in various manners. For example, the time value associated with the health care data may be the time at with the data storage system in particular or the health care information system in general received the health care data. Alternatively, the time value may be the time as which the health care data was originally created, such as by the source of the health care data, by the health care organization performing the medical procedure, test or other medical service on behalf of the patient of the like. The time value may be represented in various manners including as a specific value or as a time interval, such as a time interval during which the health care data was received and/or created.

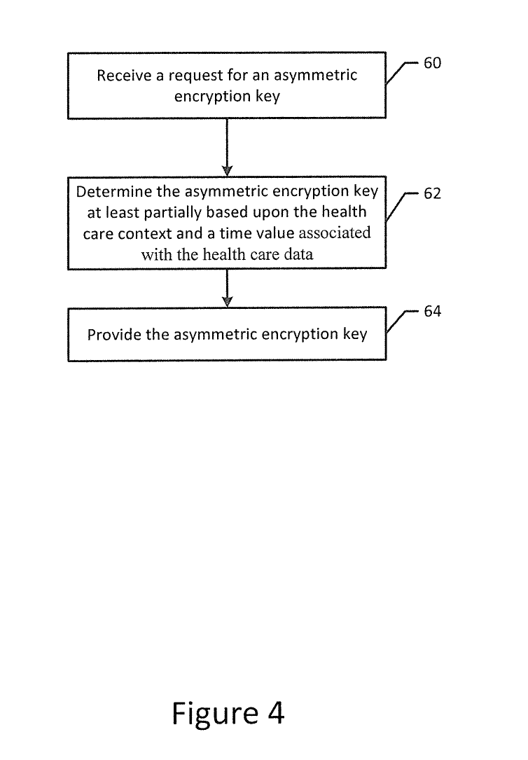

Based at least partially upon the health care context and the time value and as described below in conjunction with operations of the key management and decryption system 37 as depicted in FIG. 4, the data storage system also includes means, such as the processing circuitry 12, the processor 14, the communication interface 18 or the like, for receiving the asymmetric encryption key that is at least partially based upon the health care context and the time value. See block 54. For example, the asymmetric encryption key may be received within an encrypting certificate. By being at least partially based upon the health care context and the time value associated with the health care data, the data storage system of an example embodiment receives a different asymmetric encryption key for health care data having a different health care context. Similarly, the data storage system of this example embodiment receives a different asymmetric encryption key for health care data having a different time value. Thus, the asymmetric encryption key that is received for health care data having a first health care context will be different than the asymmetric encryption key received for health care data having a second health care context, different than the first health care context. Similarly, the asymmetric encryption key that is received for health care data associated with a first time value will be different than the asymmetric encryption key received for health care data associated with a second time value, different than the first time value. In this regard, the key management and decryption system may repeatedly generate a different asymmetric encryption key pair for each different health care context at a time interval that may be predefined or may be configurable, such as by a user or an administrator.

Upon receipt of the asymmetric encryption key, the data storage system includes means, such as the processing circuitry 12, the processor 14 or the like, for encrypting the health care data utilizing the asymmetric encryption key as shown in block 56 of FIG. 3. For example, the data storage system may receive the public key of a public/private key pair and, as a result, may encrypt the health care data with the public key. In addition, the data storage system includes means, such as the processing circuitry 12, the processor 14, the memory 16 or the like, for storing the health care data as encrypted, along with representations of the health care context and the time value. See block 58 of FIG. 3. The representations of the health care context and the time value may be the health care context and the time value themselves or other representations of the health care context and the time value. The representations of the health care context and the time value may be stored along with the encrypted health care data in various manners including, for example, as metadata associated with the encrypted health care data or as separate data elements that are associated with the encrypted health care data.

Thus, the data storage system of an example embodiment provides for the storage of encrypted health care data with the encrypted health care data being encrypted with an asymmetric encryption key that is at least partially based upon the health care context and the time value associated with the health care data. As such, if the asymmetric encryption key with which the health care data was encrypted was obtained and utilized in an unauthorized manner, such as in the event of a data breach, the only data that could be decrypted and which would therefore be subject to the data breach would be the health care data that was encrypted with the same asymmetric encryption key. In other words, the only health care data that could be decrypted during such a data breach would be the health care data that has the same health care context and the same time value since health care data having a different health care context or a different time value would be encrypted with a different asymmetric encryption key. As such, the data storage system not only securely stores encrypted health care data, but also controllably limits the extent of any data breach based upon the utilization of asymmetric encryption keys that are partially based upon the health care context and the time value associated with the health care data.

Referring now to FIG. 4, the operations performed by the health care information system and, more particularly, by a key management and decryption system 37 of the health care information system in accordance with an example embodiment in order to assign an asymmetric encryption key with which the data storage system is to encrypt health care data is depicted. As shown in block 60 of FIG. 4, the key management and decryption system of an example embodiment includes means, such as the processing circuitry 12, the processor 14, the communication interface 18 or the like, for receiving a request for an asymmetric encryption key. As described above with respect to FIG. 3, the requests are generally provided by a data storage system in response to the receipt of health care data. As also described above, the request for the asymmetric encryption key includes the health care context and the time value associated with the health care data to be encrypted.

The key management and encryption system 37 of this example embodiment also includes means, such as the processing circuitry 12, the processor 14 or the like, for determining the asymmetric encryption key that is at least partially based upon the health care context and the time value. See block 62. As described above, the key management and decryption system, such as the processing circuitry, e.g., the processor, defines or identifies different asymmetric encryption keys for use with health care data that is associated with different health care context and different time values. Accordingly, the key management and decryption system of an example embodiment, such as the processing circuitry, e.g., the processor, is configured to associate different asymmetric encryption keys with the health care data by generating an asymmetric encryption key based on the health care context and the time value associated with the health care data. Consequently, health care data having a different health care context or health care data having the same health care context, but associated with a different time value will have a different asymmetric encryption key generated therefore.

In an example embodiment, the key management and decryption system 37 is configured to generate an asymmetric encryption key pair based on the health care context and the associated time value. As described above, the key management and decryption system may repeatedly generate a different asymmetric encryption key pair for each different health care context at a time interval, such as a predefined or configurable time period. The asymmetric encryption key pair includes a first asymmetric encryption key and a second asymmetric encryption key associated therewith. For example, the first and second asymmetric encryption keys that define the asymmetric encryption key pair may be public and private keys. In an embodiment in which the first and second asymmetric encryption keys are the private and public keys, respectively, the key management and decryption system 37 may maintain the first asymmetric encryption key, such as in memory 16, and may provide the second asymmetric encryption key to the data storage system for use in conjunction with encrypting the health care data.

As such, the key management and decryption system 37 of an example embodiment also includes means, such as the processing circuitry 12, the processor 14, the communication interface 18 or the like, for providing the asymmetric encryption key, such as the second asymmetric encryption key, to the data storage system in response to the request. See block 64 of FIG. 4. For example, an encrypting certificate including the second asymmetric encryption key may be provided to the data storage system. As such, the data storage system may thereafter appropriately encrypt the health care data with the second asymmetric encryption key that is at least partially based upon and is different depending upon the health care context and the time value associated with the health care data.

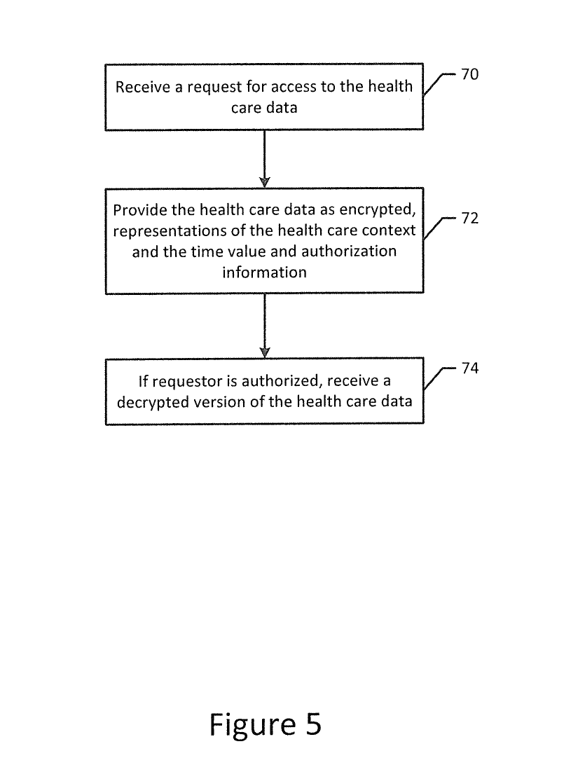

Referring now to FIG. 5, the operations performed by the data storage system in accordance with an example embodiment of the present invention in order to respond to a request for access to the encrypted health care data that is stored by the data storage system are provided. In this example embodiment, the data storage system includes means, such as the processing circuitry 12, the processor 14, the communication interface 18 or the like, for receiving a request for access to the health care data by a requestor. See block 70. The requestor may be an individual, such as the patient, a health care provider or the like, or an organization or other entity, such as a health care system, a medical practice, an insurance company, a pharmaceutical company or the like.

In response to the request, the data storage system includes means, such as the processing circuitry 12, the processor 14, the communication interface 18 or the like, for providing the health care data as encrypted, representations of the health care context and the time value associated with the health care data and authorization information associated with the requestor. See block 72 of FIG. 5. In this regard, the data storage system provides the encrypted health care data and the other associated information to the key management and decryption system 37 to determine if decryption is authorized and, if so, to receive a decrypted version of the health care data. In order to provide the encrypted health care data and the representations of the health care context and the time value associated with the health care data, the data storage system, such as the processing circuitry, the processor, the memory 16 or the like, initially retrieves from memory the health care data as encrypted along with the representations of the health care context and the time value associated with the health care data that have been stored along with the encrypted health care data. As noted above, the representations of the health care context and the time value associated with the health care data may be the health care context and the time value themselves or some other representation of the health care context and the time value associated with the health care data.

Various types of authorization information may be associated with the requestor and provided to the key management and decryption system 37. The authorization information of an example embodiment identifies the health care context and the time value associated with the health care data for which the requestor is authorized to access. Although the requestor may provide authorization information in the form of the health care context and the time value associated with the health care data for which the requestor is authorized to access, the requestor may, instead, provide information identifying the requestor, the organization represented by the requestor, the function performed by the requestor and/or the level of sensitivity of the health care data that the requestor is authorized to access and either the key management and decryption system or the data storage system determines, based upon the information provided by the requestor, the authorization information in the form of the health care context and the time value associated with the health care data for which the requestor is authorized to access.

For example, the information provided by the requestor may identify the requestor, such as by name or other form of identification. Additionally or alternatively, the information provided by the requestor may identify the health care organization with which the requestor is associated or may identify the requestor as the patient. Based upon the information that is provided that identifies the requestor, the data storage system or the key management and decryption system 37 is configured to determine the health care context and the time value associated with the health care data for which the requestor is authorized to access. For example, the data storage system or the key management and decryption system may maintain, such as in memory 16, an association between the various forms of information provided by the requestor and the health care context and the time value associated with the health care data for which the requestor is authorized to access. Thus, the data storage system or the key management and decryption system of this example embodiment is configured to retrieve the authorization information regarding the health care context and the time value associated with the health care data for which the requestor is authorized to access based upon the information, e.g., identification information, provided by the requestor.

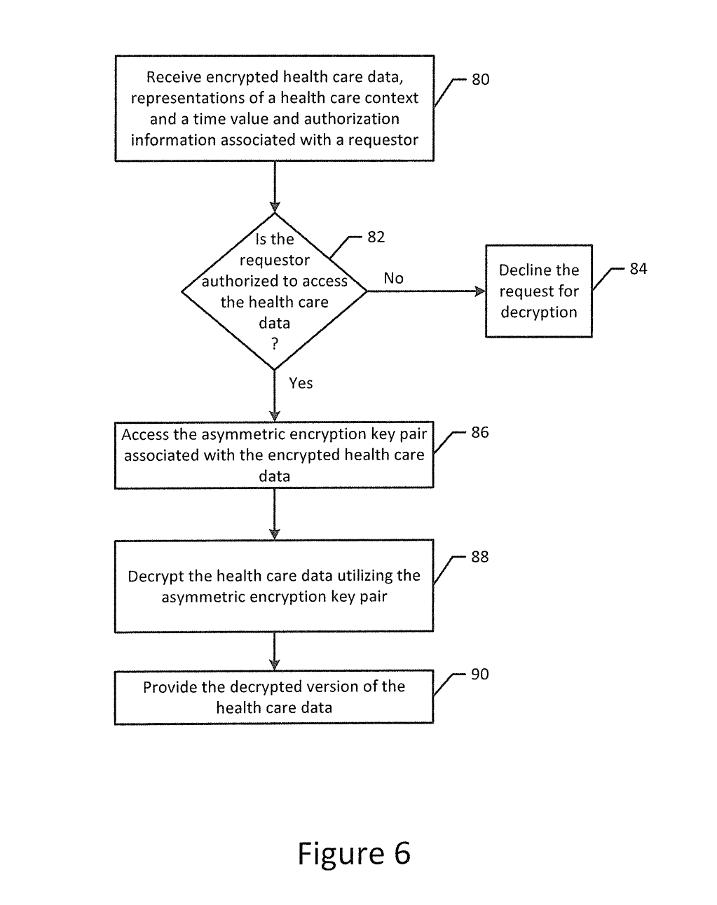

As described below, such as in the conjunction with FIG. 6, the key management and decryption system 37 determines, based upon the authorization information, if the requestor is authorized to access the health care data that has been requested and, if so, provides a decrypted version of the health care data to the data storage system. As shown in block 74 of FIG. 5, the data storage system of this example embodiment therefore also includes means, such as the processing circuitry 12, the processor 14, the communication interface 18 or the like, for receiving a decrypted version of the health care data. The data storage system may, in turn, provide the decrypted version of health care data to the requestor. However, in an instance in which the requestor is not authorized to access the health care data that has been requested, the key management and decryption system may notify the data storage system of the disallowance of the request such that the data storage system may, in turn, advise the requestor. The data storage system may also maintain a log or other record of the requestor, the response to the request, e.g., the provision of the decrypted health care data or a notification that the request was denied, and the time at which the response to the request was provided to the requestor.

Referring now to FIG. 6, the operations performed by a key management and decryption system 37 in order to determine if access is to be granted to encrypted health care data and, if so, to provide a decrypted version of health care data are provided. As shown in block 80 of FIG. 6, the key management and decryption system includes means, such as the processing circuitry 12, the processor 14, the communications interface 18 or the like, for receiving encrypted health care data, representations of the health care context and the time value associated with the health care data and authorization information associated with the requestor that requested access to the health care data. As described above, the encrypted health care data and the associated information may be provided by a data storage system in response to the request by the requestor. Although the authorization information or at least some of the authorization information associated with the requestor may be provided by the data storage system as described above, the key management and decryption system, such as the processing circuitry, the processor, the memory 16 or the like, may store authorization information associated with various requesters. As such, in response to the identification of requestor, such as the name, function or role of a requestor, the organization with which the requestor is affiliated or the level of sensitivity of the health care data that the requestor is authorized to access, the key management and decryption system, such as the processing circuitry, the processor, the memory or the like, may access and retrieve the authorization information that is stored. As described above, the authorization information identifies the health care context and the time value associated with the health care data for which the requestor is authorized to access based upon the information, e.g., identification information, provided by the requestor.

As shown in block 82 of FIG. 6, the key management and decryption system 37 also includes means, such as the processing circuitry 12, the processor 14 or the like, for determining whether the requestor is authorized to access the health care data. In this regard, the key management and decryption system, such as the processing circuitry, is configured to compare the authorization information associated with the requestor to the health care context and the time value associated with the healthcare data. For example, the authorization information may identify the level of sensitivity of the health care data that may be accessed by the requestor, the source of the health care data that may be accessed by the requestor as well as the time interval with which the health care data must be associated so as to be accessed by the requestor. By comparing the health care context and the time value associated with the health care data and determining if the authorization information that is associated with requestor matches or is otherwise consistent with the health care context and the time value associated with health care data, the key management and decryption system, such as the processing circuitry, may determine whether the requestor is authorized to access the health care data, such as in the instance when the authorization information matches the health care context and the time value associated with the health care data, or is not authorized access to health care data, such as in an instance which the authorization information does not match the health care context and the time value associated with the health care data.

In an instance in which the key management and decryption system 37, such as the processing circuitry 12, determines that the requestor is not authorized to access the healthcare data, the key management and decryption system includes means, such as the processing circuitry, the processor 14, the communication interface 18 or the like, for declining the request for decryption of the healthcare data and provides a responsive message to the data storage system advising of the declination of the request, such as due to the requestor being unauthorized to access the health care data. See block 84.

However, in an instance in which the requestor is authorized access the health care data, the key management and decryption system 37 of an example embodiment includes means, such as the processing circuitry 12, the processor 14 or the like, for decrypting the health care data and means, such as the processing circuitry, the processor, the communication interface 18 or the like, for providing a decrypted version of the health care data to the data storage system for provision, in turn, to the requestor. See blocks 88 and 90 of FIG. 6. In order to decrypt the encrypted health care data that is provided by the data storage system, the key management and decryption system of an example embodiment includes means, such as the processing circuitry, the processor, the memory 16 or the like, for accessing an asymmetric key pair, such as an asymmetric encryption key pair stored by the memory. See block 86 of FIG. 6. The asymmetric encryption key pair includes a first asymmetric encryption key and an associated second asymmetric encryption key. The first and second asymmetric encryption keys may be a pair of private and public keys, respectively, as described above. As also described above, the health care data that is provided in an encrypted format by the data storage system may have been encrypted by the second asymmetric encryption key. As such, the key management and decryption system, such as the processing circuitry, of this example embodiment is configured to decrypt the health care data utilizing the first asymmetric encryption key, that is, the private encryption key.

The key management and decryption system 37 may then provide the decrypted version of the health care data to the data storage system and, in turn, to the requestor. However, the requestor is only able to access the decrypted version of the health care data after the health care information system, such as the key management and decryption system, has determined that the requestor has appropriate authorization to access the health care data and the health care data has, in turn, been appropriately decrypted. As such, access to the health care data is strictly controlled and, as described above, the extent of the data access that is accessible even in the event of a data breach is limited based upon the health care context and the associated time value, thereby providing additional protection in the event of a data breach.

As described above, FIGS. 3 and 5 are flowcharts of a data storage system, method and computer program product according to example embodiments of the invention. In addition, FIGS. 4 and 6 are flowcharts of a key management and decryption system, method and computer program product according to example embodiments of the invention.

It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 16 and executed by processor 14 of the computer system of FIG. 1. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 12 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A key management and decryption system configured to secure health care data, the key management and decryption system comprising processing circuitry configured to:
receive encrypted health care data, representations of a health care context and a time value associated with the health care data, and authorization information associated with a requestor that has requested access to the health care data;
determine whether the requestor is authorized to access the health care data based upon an analysis of the authorization information relative to the health care context and the time value associated with the health care data; and
in an instance in which the requestor is authorized to access the health care data, decrypt the health care data and provide a decrypted version of the health care data.

2. A key management and decryption system according to claim 1 wherein the processing circuitry is further configured to access an asymmetric encryption key pair including a first asymmetric encryption key that is associated with a second asymmetric encryption key with which the health care data is encrypted, and wherein the processing circuitry is configured to decrypt the health care data by decrypting the health care data with the first asymmetric encryption key.

3. A key management and decryption system according to claim 2 wherein the processing circuitry is further configured to:
receive a request for an asymmetric encryption key, wherein the request for the asymmetric encryption key includes the health care context and the time value associated with the health care data to be encrypted;
determine the second asymmetric encryption key that is at least partially based upon the health care context and the time value; and
provide the second asymmetric encryption key in response to the request.

4. A key management and decryption system according to claim 2 wherein the processing circuitry is further configured to associate different asymmetric encryption key pairs with health care data associated with different health care contexts and different time values.

5. A key management and decryption system according to claim 4 wherein the processing circuitry is configured to associate different asymmetric encryption key pairs by generating asymmetric encryption key pairs based on the health care context at a time interval.

6. A key management and decryption system according to claim 1 wherein the health care context includes one or more of a health care organization, a patient, a level of sensitivity associated with the health care data, a health care practice that provided the health care data or a health care system that received the health care data.

7. A method of a key management and decryption system for securing health care data, the method comprising:
receiving encrypted health care data, representations of a health care context and a time value associated with the health care data, and authorization information associated with a requestor that has requested access to the health care data;
determining whether the requestor is authorized to access the health care data based upon an analysis of the authorization information relative to the health care context and the time value associated with the health care data; and
in an instance in which the requestor is authorized to access the health care data, decrypting the health care data and providing a decrypted version of the health care data.

8. A method according to claim 7 further comprising accessing an asymmetric encryption key pair including a first asymmetric encryption key that is associated with a second asymmetric encryption key with which the health care data is encrypted, and wherein decrypting the health care data comprises decrypting the health care data with the first asymmetric encryption key.

9. A method according to claim 8 further comprising:
receiving a request for an asymmetric encryption key, wherein the request for the asymmetric encryption key includes the health care context and the time value associated with the health care data to be encrypted;
determining the second asymmetric encryption key that is at least partially based upon the health care context and the time value; and
providing the second asymmetric encryption key in response to the request.

10. A method according to claim 8 further comprising associating different asymmetric encryption key pairs with health care data associated with different health care contexts and different time values.

11. A method according to claim 10 wherein associating different asymmetric encryption key pairs comprises generating asymmetric encryption key pairs based on the health care context at a time interval.

12. A method according to claim 7 wherein the health care context includes one or more of a health care organization, a patient, a level of sensitivity associated with the health care data, a health care practice that provided the health care data or a health care system that received the health care data.

13. A data storage system configured to securely store health care data, the data storage system comprising processing circuitry configured to:
receive health care data having an associated health care context;
request an asymmetric encryption key, wherein the request for the asymmetric encryption key includes the health care context and a time value associated with the health care data;
receive the asymmetric encryption key that is at least partially based upon the health care context and the time value;
encrypt the health care data utilizing the asymmetric encryption key; and
store the health care data, as encrypted along with representations of the health care context and the time value.

14. A data storage system according to claim 13 wherein the processing circuitry is configured to receive the asymmetric encryption key by receiving a different asymmetric encryption key for health care data having a different health care context or a different time value.

15. A data storage system according to claim 14 wherein the health care context includes one or more of a health care organization, a patient, a level of sensitivity associated with the health care data, a health care practice that provided the health care data or a health care system that received the health care data.

16. A data storage system according to claim 13 wherein the processing circuitry is further configured to:
receive a request for access to the health care data by a requestor;
provide the health care data as encrypted, representations of the health care context and the time value associated with the health care data and authorization information associated with the requestor; and
in an instance in which the requestor is determined to be authorized to access the health care data, receive a decrypted version of the health care data.

17. A method for securely storing health care data, the method comprising:
receiving health care data having an associated health care context;
requesting an asymmetric encryption key, wherein the request for the asymmetric encryption key includes the health care context and a time value associated with the health care data;
receiving the asymmetric encryption key that is at least partially based upon the health care context and the time value;
encrypting the health care data utilizing the asymmetric encryption key; and
storing the health care data, as encrypted along with representations of the health care context and the time value.

18. A method according to claim 17 wherein receiving the asymmetric encryption key comprises receiving a different asymmetric encryption key for health care data having a different health care context or a different time value.

19. A method according to claim 18 wherein the health care context includes one or more of a health care organization, a patient, a level of sensitivity associated with the health care data, a health care practice that provided the health care data or a health care system that received the health care data.

20. A method according to claim 17 further comprising:
receiving a request for access to the health care data by a requestor;
providing the health care data as encrypted, representations of the health care context and the time value associated with the health care data and authorization information associated with the requestor; and
in an instance in which the requestor is determined to be authorized to access the health care data, receiving a decrypted version of the health care data.
